(19) United States
(12) Patent Application Publication
(10) Pub. No.: US 2010/0002445 A1
(43) Pub. Date: Jan. 7, 2010

(54) LIGHT EMITTING DIODE STREETLIGHT APPARATUS

(75) Inventors: YAO-MIN TSENG, Chu-Nan (TW); CHIH-MING LAI, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/485,931

(22) Filed: Jun. 17, 2009

(30) Foreign Application Priority Data
Jul. 2, 2008 (CN) 200810302495.8

(51) Int. Cl. F21V 7/00; F21S 6/00

(52) U.S. Cl. 362/296.01; 362/257

(57) ABSTRACT

An exemplary light emitting diode (LED) streetlight apparatus includes a support, a light emitting module and a light guiding device. The light emitting module is mounted on the support for emitting light. The light emitting module has a first radiation angle in a plane perpendicular to the surface of the road, and the first radiation angle is equal to or less than 45 degrees. The light emitting module has a second radiation angle in a plane parallel to the surface of the road, and the second radiation angle is greater than the first radiation angle. The light emitted from the light emitting module is directed by the light guiding device to emit in a direction towards the surface of the road.

### BACKGROUND

1. Technical Field

The present disclosure generally relates to light emitting diode streetlight apparatus, and particularly to a light emitting diode streetlight apparatus capable of illuminating a road without causing glare to automobile drivers.

2. Discussion of Related Art

In the design of roadways, safety is always a major concern. One factor in the design of a safe road is lighting, so that the automobile driver is able to clearly see his surroundings at night. That is why streetlights were placed on roads. Most streetlights, however, use light inefficiently by dispersing light to where it is not needed. Such improper shielding leads to decreased visibility. One attempt by inventors and lighting companies to solve the problem of inefficient lighting was to use larger quantities of light to illuminate an area. This, however, is actually less efficient because large quantities of light can cause glare.

Therefore, what is needed is a streetlight apparatus that can overcome the described limitations.

### BRIEF DESCRIPTION OF THE DRAWINGS

Many aspects of the disclosed light emitting diode streetlight apparatus can be better understood with reference to the following drawings. The components in the drawings are not necessarily drawn to scale, the emphasis instead being placed upon clearly illustrating the principles of the present light emitting diode streetlight apparatus. Moreover, in the drawings, all the views are schematic, and like reference numerals designate corresponding parts throughout the several views.

FIG. 1 is a schematic view of a light emitting diode streetlight apparatus, according to a first embodiment.

FIG. 2 is schematic view of a light emitting diode streetlight apparatus, according to a second embodiment.

FIG. 3 is a schematic top view of illuminated area of the present disclosed LED streetlight apparatuses which are aligned along a single side of a road.

FIG. 4 is a schematic top view of illuminated area of the present disclosed LED streetlight apparatuses which are aligned along both sides of a road.

### DETAILED DESCRIPTION

Reference will now be made to the drawings to describe various embodiments of the present light emitting diode streetlight apparatus, in detail.

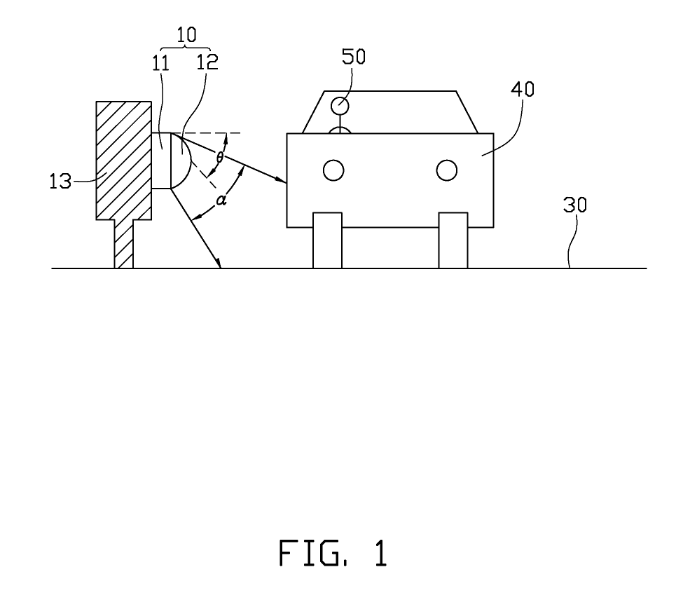

Referring to FIG. 1, a light emitting diode (LED) streetlight apparatus 10, according to a first embodiment, includes a support 13, a light emitting module 11 for emitting lights and a light guiding device 12 for guiding the lights in a direction towards a surface of a road 30.

The light emitting module 11 is mounted on the support for emitting light. The light emitting module 11 may include a single diode or a plurality of light emitting diodes. In an exemplary embodiment, the light emitting module 11 includes a plurality of light emitting diodes.

The light guiding device 12 is arranged opposite to the light emitting module 11, thereby receiving and guiding the light emitted from the light emitting module 11. In an exemplary embodiment, the light guiding device 12 includes an axis offset optical element capable of transmitting lights. When passing through the light guiding device 12, light emitted from the light emitting module 11 will be directed by the light guiding device 12, to emit in a direction towards the surface of the road 30. The axis offset optical element also has three functions as follows.

Firstly, the light guiding device 12 reduces a first radiation angle “α”, in a plane perpendicular to a extending direction of the road 30, of the light emitting module 11 to be equal to or less than 45 degrees. Still further, the first radiation angle “α” can also be equal to or less than 30 degrees. It is to be said that, in FIG. 1, the extending direction of the road 30 is perpendicular to the paper plane.

Secondly, the light guiding device 12 enlarges a second radiation angle, along the extending direction of the road 30, of the light emitting module 11 to be greater than the first radiation angle “α”. The second radiation angle can be greater than or equal to 60 degrees. Still further, the second radiation angle can also be greater than or equal to 120 degrees. Therefore, light emitted from the light emitting module 11 has a largest possible coverage area on the road 30.

Thirdly, the light guiding device 12 adjusts an axis of the light emitting module 11, so that an angle between the optic axis and the surface of the road 30 is equal to or greater than half of the first radiation angle “α”.

The light emitting module 11 is at an altitude relatively lower than (below) the plane of view of the automobile driver, for example has a height equal to or less than 1.1 meter, which is relatively low in a majority cars. Furthermore, the lights emitted from the light emitting module 11 are directed in a direction towards the surface of the road 30. As such, the LED streetlight apparatus 10 illuminates the road 30 without shining light directly into the eyes of automobile drivers 50. Thereby, the LED streetlight apparatus 10 avoids glare affecting the automobile drivers 50. Additionally, light emitting diodes have high luminous efficiency and low power consumption, thereby the LED streetlight apparatus 10 is efficient.

Alternatively, the height of the light emitting module 11 can also be lower than the window sill of the automobiles 40. Because the window sill of the automobiles 40 is usually lower than the eyes of automobile drivers, glare to automobile drivers 50 can also be avoided in this condition.

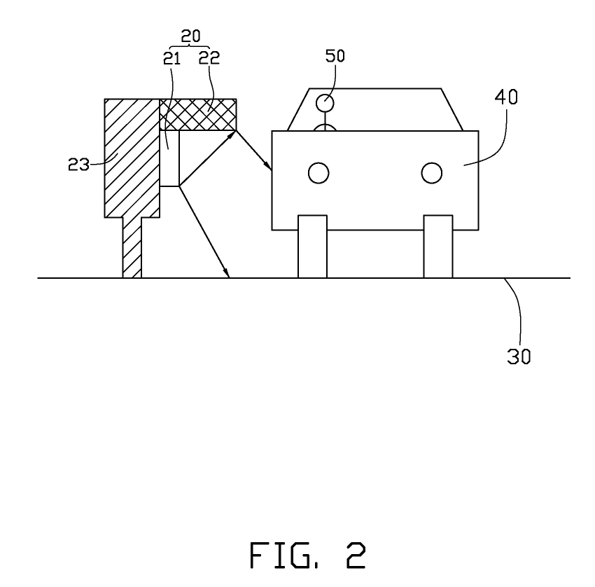

Referring to FIG. 2, a LED streetlight apparatus 20, according to a second embodiment, includes a support 23, a light emitting module 21 and a light guiding device 22. The light emitting module 21 is mounted on the support 23 and similar to the light emitting module 11. The light guiding device 22 is a light reflecting element for reflecting lights emitted from the light emitting module 21 back and in a direction towards the surface of the road 30.

The light guiding device 22 is arranged above the light emitting module 21. The light guiding device 22 can be a light reflect board or a light reflect cover, which includes a reflecting surface. Lights emitted from the light emitting module 21 will partly upward incident onto the reflecting surface of the light guiding device 22, and be reflected back and at a direction down towards the surface of the road 30 in succession. As such, the LED streetlight apparatus 20 illuminates the road 30 without shining light directly into the eyes of automobile drivers. Thereby, glare to automobile drivers are avoided.

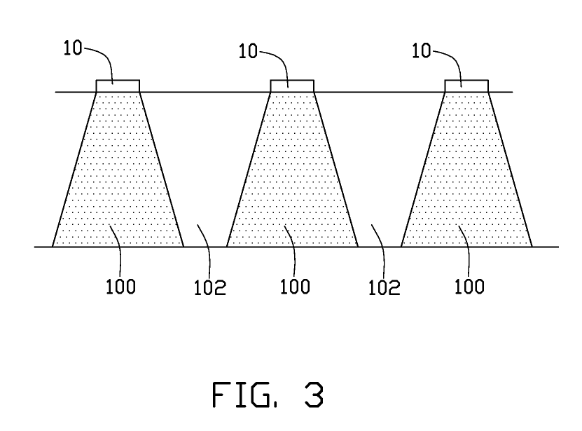

Referring to FIG. 3, a top view of illuminated area of the present disclosed LED streetlight apparatuses 10 is illustrated. The LED streetlight apparatuses 10 are aligned along a single side of the road 30. Each illuminated area 100 of the LED streetlight apparatuses 10 has a shape of sector, and the areas 102 are not illuminated.

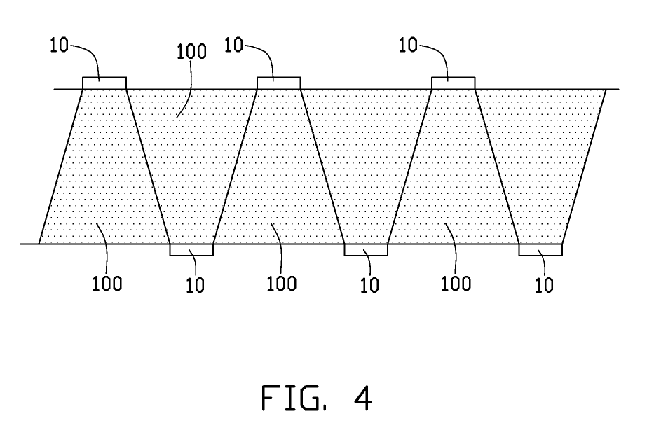

Referring to FIG. 4, the LED streetlight apparatuses 10 are alternately aligned along both sides of the road 30. Thereby, the whole surface of the road 30 is illuminated.

Finally, it is to be understood that the above-described embodiments are intended to illustrate rather than limit the disclosure. Variations may be made to the embodiments without departing from the spirit of the invention as claimed. The above-described embodiments illustrate the scope of the disclosure but do not restrict the scope of the disclosure.

What is claimed is:

1. A light emitting diode (LED) streetlight apparatus for illuminating a surface of a road without causing glare to automobile drivers, the LED streetlight apparatus comprising
a support;
a light emitting module mounted on the support for emitting light and
a light guiding device for guiding the light emitted from the light emitting module in a manner that the light emitted from the light emitting module are directed, by the light guiding device, to emit in a direction towards the surface of the road; the light emitting module has a first radiation angle in a plane perpendicular to the surface of the road, the first radiation angle is equal to or less than 45 degrees; the light emitting module has a second radiation angle along the extending direction of the road, and the second radiation angle is larger than the first radiation angle.

2. The LED streetlight apparatus according to claim 1, wherein the light emitting module is at an altitude equal to or less than 1.1 meter.

3. The LED streetlight apparatus according to claim 1, wherein the first radiation angle is less than or equal to 30 degrees.

4. The LED streetlight apparatus according to claim 1, wherein the second radiation angle is greater than or equal to 60 degrees.

5. The LED streetlight apparatus according to claim 4, wherein the second radiation angle is greater than or equal to 120 degrees.

6. The LED streetlight apparatus according to claim 1, wherein the light guiding device is configured for reducing the first radiation angle in the plane perpendicular to the surface of the road.

7. The LED streetlight apparatus according to claim 6, wherein the light guiding device comprises an axis offset optical element for allowing the light to pass therethrough, and altering the transmitting direction thereof.

8. The LED streetlight apparatus according to claim 6, wherein the light guiding device comprises a light reflecting element for reflecting the light to the surface of the road.

9. The LED streetlight apparatus according to claim 8, wherein the light guiding device comprises a light reflecting surface.
